(19) United States
(12) Patent Application Publication
(10) Pub. No.: US 2015/0230473 A1
(43) Pub. Date: Aug. 20, 2015

(54) A COMPOSITION FOR INCREASING THE YIELD, AND METHODS OF INCREASING THE YIELD OF CROP BY USING THE SAME

(71) Applicant: DOOSAN CORPORATION, Seoul (KR)

(72) Inventors: Soo Yong Choe, Seongnam-si (KR); Chung Kil Kang, Osan-si (KR); Il Choi, Seoul (KR)

(73) Assignee: DOOSAN CORPORATION, Seoul (KR)

(21) Appl. No.: 14/351,794

(22) PCT Filed: Dec. 18, 2013
(86) PCT No.: PCT/KR2013/011810

§ 371 Date: Apr. 14, 2014

(30) Foreign Application Priority Data
Dec. 21, 2012 (KR) 10-2012-0151033
Mar. 28, 2013 (KR) 10-2013-0033776

(51) Int. Cl. A01N 57/12

(52) U.S. Cl. CPC A01N 57/12

(57) ABSTRACT

The present invention relates to a composition for increasing the yield of a plant, and a method for increasing the yield of a plant by using the same, and more particularly, to a composition for increasing the yield of the plant, which includes at least one of lysophosphatidylethanolamine and lecithin, and a method for increasing the yield of plant by applying the same to the plant to promote the yield increase of the plant.

### TECHNICAL FIELD

The present invention relates to a composition for increasing the yield of a plant, and a method for increasing the yield of a plant by using the same.

### BACKGROUND ART

Plant growth regulators have characteristics of promoting growth and development of a plant even when used in a small amount unlike other insecticides, herbicides and fertilizers, and auxin, gibberellin, cytokinin, abscisic acid (ABA), ethylene, brassinolide and the like are known as examples thereof.

Among the materials, auxin usually affects the yield increase of the plant. Specifically, the yield increase is closely associated with a fruit set, pollination or fruiting, and among them, the yield increase efficiency of the plant is increased when the size of the plant ovary is grown as a result of good pollination. Herein, as auxin, which is a plant growth hormone, is produced in the plant ovary by pollination, the size of the plant ovary is grown, and accordingly, the yield increase efficiency (parthenocarpy of parthenogenetic plants) of the plant varies depending on the level of auxin in the plant.

Therefore, in order to enhance the yield increase efficiency of the plant, various synthetic auxin compounds have been developed, and effects of improved fruit set or promotion of fruit enlargement may be obtained by treating the plant with the developed synthetic auxin compound.

However, when the synthetic auxin compound is used at a concentration equal to or higher than the standard concentration or repeatedly sprayed during a high temperature period, the occurrence of hollow fruit becomes severe, and particularly when the chemical liquid touches the growing point area, there are side effects in that deformities of a plant are caused, and the growth becomes poor.

Therefore, a material, which does not cause side effects such as deformities, poor growth and the like of the plant nor adversely effects humans and the environment but can effectively promote the yield increase of a plant, has been continuously developed, but there still remains a limitation in obtaining a satisfactory result.

### DISCLOSURE

### Technical Problem

The present invention has been made in an effort to solve the aforementioned problem, and an object of the present invention is to provide a composition for increasing the yield of a plant by which the yield increase of a plant may be effectively obtained without causing side effects such as deformities and poor growth of the plant, and a method for increasing the yield of the plant by using the same.

### Technical Solution

In order to achieve the above object, the present invention provides a composition for increasing the yield of a plant, including at least one of lysophosphatidylethanolamine (LPE) and lecithin.

According to an aspect of the present invention, the composition for increasing the yield of the plants characterized to further include at least one of a fatty acid having 3 to 22 carbon atoms and salts thereof, and a mixed solvent of water and alcohol.

According to an aspect of the present invention, at least one of lysophosphatidylethanolamine (LPE) and lecithin is characterized to be included in an amount of 1 to 50% by weight based on the total weight of the composition.

According to an aspect of the present invention, at least one of the fatty acid and salts thereof, and the mixed solvent are characterized to be included in an amount of 0.001 to 60% by weight and 10 to 99.9% by weight, respectively, based on the total weight of the composition.

According to an aspect of the present invention, the salt of the fatty acid is characterized to be at least one selected from the group consisting of sodium salts, potassium salts, ammonium salts and ethanolamine salts.

According to an aspect of the present invention, the alcohols characterized to be at least one selected from the group consisting of ethanol, isopropanol, butanol, hexanol and oleyl alcohol.

According to an aspect of the present invention, the mixed solvent is characterized to have a volume ratio of water:ethanol or isopropanol:butanol:hexanol:oleyl alcohol of 1:0.4 to 4.0 or 0.2 to 2.0:0.2 to 2.0:0.2 to 2.0:0.1 to 1.0.

According to an aspect of the present invention, a method for increasing the yield of the plant according to the present invention is characterized in that the composition for increasing the yield of the plant is applied to the treatment of at least one plant selected from the group consisting of corn, rice, barley, sorghum and wheat.

According to an aspect of the present invention, the method for increasing the yield of the plant is characterized in that a primary treatment is performed with the composition for increasing the yield of the plant before or after plants come into ears.

### DESCRIPTION OF DRAWINGS

FIG. 1 is a graph illustrating a summarized experimental result of corn.

FIG. 2 is a graph illustrating a summarized experimental result of rice.

### BEST MODE

Hereinafter, the present invention will be described.

The term “plant growth promotion” in the present invention is a concept that includes all germination promotion of plant seeds, promotion of plant length and volume growth, enhancement of leaf activity, promotion of growth of plant roots, an increase in the number of fruits, an increase in the volume of fruit, promotion of fruit set of fruits, promotion of ripening of fruits, an increase in the number, enhancement of productivity, and the like.

The composition for increasing the yield of the plant according to the present invention (hereinafter, referred to as ‘composition’) is characterized to include at least one of lysophosphatidylethanolamine (LPE) and lecithin.

Lysophosphatidylethanolamine (LPE) naturally exists in the cells of animals and plants, and is contained at a high concentration particularly in the yolk or soybean. The lysophosphatidylethanolamine is derived from phosphatidylethanolamine which is a kind of phospholipids found in a cell membrane. The phosphatidylethanolamine plentiful in the yolk or soy lecithin is a kind of phospholipids and contains two fatty acids in a molecule thereof. In a living organism, phosphatidylethanolamine is subject to an action of phospholipase A2, which is a phospholipid hydrolase, and is converted into lysophosphatidylethanolamine as one fatty acid located at an sn-2 position is removed. The lysophosphatidylethanolamine usefully serves to promote the growth of the plant and prevent the senescence.

The composition of the present invention may include the lysophosphatidylethanolamine to promote the growth of the plant, thereby enhancing the yield increase efficiency of the plant.

Since the lysophosphatidylethanolamine included in the composition of the present invention is a material which naturally exists in animals and plants as described above, materials separated and purified from nature may be used. Particularly, the material may be separated from lecithin of soybean or yolk and the like.

Specifically, crude soy lecithin (often referred to as crude lecithin) which is produced as by-product during the production of soybean milk consists of 60 to 70% of polar lipid (phospholipid/glycolipid), 27 to 39% of soybean milk, 1 to 3% of water and 0.5 to 3% of other components. Among them, the polar lipid is purified by removing the soybean milk which is a neutral lipid included in the crude lecithin, and the purified polar lipid consists of 22 to 30% of phosphatidylcholine (PC), 2 to 5% of lysophosphatidylcholine (LPC), 16 to 22% of phosphatidylethanolamine (PE), 0.5 to 2% of lysophosphatidylethanolamine (LPE), 0.5 to 8% of phosphatidic acid (PA), 0.1 to 3% of phosphatidyl serine (PS), 6 to 15% of phosphatidylinositol (PI), and the like.

The egg lecithin also consists of 73 to 83% of phosphatidylcholine (PC), 2 to 5% of lysophosphatidylcholine (LPC), 13 to 17% of phosphatidylethanolamine (PE), 1 to 3% of lysophosphatidylethanolamine (LPE) and balances.

The lysophosphatidylethanolamine included in the composition of the present invention is obtained by separating or purifying the lysophosphatidylethanolamine included in the lecithin of soybean or yolk. Herein, the method of separating lysophosphatidylethanolamine is not particularly limited, but lysophosphatidylethanolamine may be obtained by reacting the soy lecithin or egg lecithin with ethanolamine.

In addition, in the present invention, phosphatidylethanolamine extracted from the nature may be hydrolyzed to lysophosphatidylethanolamine, or it is possible to use lysophosphatidylethanolamine obtained by converting phosphatidylcholine into phosphatidylethanolamine, and then again hydrolyzing phosphatidylethanolamine to lysophosphatidylethanolamine, or use hydrogenated lysophosphatidylethanolamine.

Meanwhile, the composition of the present invention may also include lecithin itself containing lysophosphatidylethanolamine. Specifically, the composition of the present invention includes the soy lecithin or the egg lecithin. However, since the soy lecithin or the egg lecithin includes a small amount of lysophosphatidylethanolamine, lecithin may be purified or chemically treated in order to increase the content of lysophosphatidylethanolamine included in lecithin. For example, it is possible to obtain modified soy lecithin in which lysophosphatidylethanolamine is enriched by treating the soy lecithin with the snake venom phospholipase A2, pancreatic phospholipase A2 or lipase, and then to use the obtained lecithin for the present invention. Examples of the specific material include enzyme modified soy lecithin from The Solae Company.

Further, examples of the lecithin included in the composition of the present invention include hydroxylated soy lecithin, hydroxylated egg lecithin, acetylated soy lecithin and acetylated egg lecithin.

The hydroxylated soy lecithin and hydroxylated egg lecithin are made to allow a hydroxyl group to be included in a double bond of fatty acid, which is contained in the lecithin, by chemically treating the soy lecithin and egg lecithin after the purification, or crude soy lecithin and egg lecithin before the purification. It is also possible to enrich lysophosphatidylethanolamine by treating the hydroxylated soy lecithin or egg lecithin with a phospholipase.

The acetylated soy lecithin and acetylated egg lecithin are made to allow an acetyl group to be included in an amine group, which is contained in the lecithin, by chemically treating the soy lecithin and egg lecithin after the purification, or crude soy lecithin and crude egg lecithin before the purification. It is possible to enrich lysophosphatidylethanolamine by treating the acetylated soy lecithin or egg lecithin with a phospholipase.

The lecithin included in the composition of the present invention is lecithin containing 3% or more, preferably 5% or more of lysophosphatidylethanolamine. Specifically, the lecithin may be selected from the group consisting of hydroxylated lecithin, acetylated lecithin and lecithin obtained by treating the hydroxylated lecithin or acetylated lecithin with an enzyme.

The content of lysophosphatidylethanolamine and/or lecithin included in the composition of the present invention is not particularly limited, but is preferably 1 to 50% by weight, more preferably 5 to 20% by weight, and even more preferably 8 to 12% by weight, based on the total weight of the composition. The most preferred content of lysophosphatidylethanolamine and/or lecithin is about 10% by weight. The reason is because stability of the composition is significantly enhanced when lysophosphatidylethanolamine and/or lecithin are/is included in the content range.

Meanwhile, the composition of the present invention may further include at least one of a fatty acid having 3 to 22 carbon atoms and salts thereof, and a mixed solvent of water and alcohol.

The fatty acid having 3 to 22 carbon atoms, which is included in the composition of the present invention, is not particularly limited, but examples thereof include saturated fatty acids having no double bond, or unsaturated fatty acids having at least one double bond between the fatty acids.

Examples of the saturated fatty acids include propionic acid, butanoic acid or butyric acid, pentanoic acid or valeric acid, hexanoic acid or caproic acid, heptanoic acid, octanoic acid or caprylic acid, decanoic acid or capric acid, undecanoic acid, dodecanoic acid or lauric acid, tridecanoic acid, tetradecanoic acid or myristic acid, pentadecanoic acid, hexadecanoic acid or palmitic acid, heptadecanoic acid or margaric acid, octadecanoic acid or stearic acid, nonadecanoic acid, icosanoic acid or arachidic acid, henicosanoic acid, docosanoic acid or behenic acid, tricosanoic acid, and tetracosanoic acid or lignoceric acid.

Examples of the unsaturated fatty acids include hexenoic acid, octenoic acid, decenoic acid, dodecenoic acid, tetradecenoic acid, hexadecenoic acid such as palmitoleic acid, octadecenoic acid such as oleic acid and petroselinic acid, docosenoic acid such as erucic acid, and the like.

In addition to the examples, as the fatty acid, it is possible to use linoleic acid, linolenic acid, arachidonic acid, and docodapentaenoic acid, which have two or more double bonds.

The fatty acid included in the composition of the present invention has preferably 8 to 14 carbon atoms, more preferably 10 to 12 carbon atoms from the viewpoint that the surface of the plant is very non-polar, and in order to allow effective components to penetrate well into or be well adhered to the surface of the plant.

The salt of the fatty acid included in the composition of the present invention is not particularly limited, but is preferably at least one selected from the group consisting of sodium salts, potassium salts, ammonium salts and ethanolamine salts. The ethanolamine salt may be one of monoethanolamine salt, diethanolamine salt and triethanolamine salt.

The content of fatty acid and/or the salt thereof included in the composition of the present invention is not particularly limited, but is preferably 0.001 to 60% by weight, more preferably 1 to 25% by weight, and even more preferably 5 to 20% by weight, based on the total weight of the composition. The most preferred content of fatty acid and the salt thereof is about 10% by weight. The reason is because when fatty acid and/or the salt thereof are/is included in the range, lysophosphatidylethanolamine or lecithin is well dissolved in an aqueous solution, and a stable dosage form may be maintained.

The mixed solvent included in the composition of the present invention consists of water and alcohol. The alcohol included in the mixed solvent is not particularly limited, but is preferably at least one selected from the group consisting of ethanol, isopropanol, butanol, hexanol and oleyl alcohol.

The mixture ratio of water and alcohol constituting the mixed solvent is not particularly limited, but may vary depending on the kind of alcohol. Specifically, when water and ethanol are mixed, the volume ratio of water:ethanol may be 1:0.4 to 4.0, and when water and isopropanol are mixed, the volume ratio of water:isopropanol may be 1:0.2 to 2.0. In addition, when water and butanol are mixed, the volume ratio of water:butanol may be 1:0.2 to 2.0, and when water and hexanol are mixed, the volume ratio of water:hexanol may be 1:0.2 to 2.0. Finally, when water and oleyl alcohol are mixed, the volume ratio of water:oleyl alcohol may be 1:0.1 to 1.0.

The content of the mixed solvent included in the composition of the present invention is not particularly limited, but is preferably 10 to 99.9% by weight, more preferably 50 to 99.8% by weight, and even more preferably 76 to 84% by weight, based on the total weight of the composition. The reason is because the solubility of lysophosphatidylethanolamine or lecithin may be increased when the mixed solvent is included in the content range.

Meanwhile, the composition of the present invention may further include at least one element of iron, boron, copper, zinc, manganese and molybdenum. Specifically, the composition of the present invention may further include a salt (for example, sodium molybdate dehydrate, manganese chloride tetrahydrate and the like) including the elements. The composition of the present invention which further includes these elements may further enhance the growth of the plant.

That is, the elements are needed for plants to grow, and when these elements are lacking, the growth of the plant may be reduced, and when the composition of the present invention, which further include the elements, is applied to the plant, the elements lacking in the plant may be supplied, thereby enhancing the growth of the plant.

Specifically, molybdenum included in the composition of the present invention reduces nitrate nitrogen, helps bacteria fixing nitrogen to grow, and is also involved in the synthesis of protein. Therefore, when molybdenum is lacking, deformity of a plant or chlorosis in which leaves turn yellow occurs, or nitrate nitrogen is accumulated in the plant and as a result, the growth of the plant is negatively affected. Furthermore, manganese helps the action of oxidase, facilitates oxidation and reduction, and is involved in the synthesis of vitamin C. Therefore, when manganese is insufficient, the size of the plant leaves is decreased or chlorosis occurs, and the content of carbohydrate, protein and vitamin C in the plant is decreased.

Accordingly, the composition of the present invention may further include the elements to prevent deformities, chlorosis, lack of nutrients and the like of the plant, which are caused by lack of the elements. The content of the elements included in the composition of the present invention is not particularly limited, but is preferably 0.5 to 5% by weight based on the total weight of the composition.

The present invention provides a method for increasing the yield of the plant which promotes the yield increase of the plant by treating the plant with a composition including at least one of lysophosphatidylethanolamine and lecithin as explained above.

The plant which is treated with the composition of the present invention is not particularly limited, but is preferably at least one selected from the group consisting of corn, rice, barley, sorghum and wheat.

Meanwhile, the composition is diluted in water in order to treat the plant with the composition, and in this case, with respect to the degree of dilution, it is preferred that dilution is performed such that the concentration of the composition is 0.01 to 10,000 ppm. That is, in the method for increasing the yield of the plant according to the present invention, the plant is treated with the composition as a diluted solution which is diluted in water, and the concentration of the composition included in the diluted solution is 0.01 to 10,000 ppm. Specifically, the concentration of the composition included in the diluted solution is more preferably 0.01 to 100 ppm.

The method for increasing the yield of the plant according to the present invention may include performing a primary treatment with the composition before or after plants come into ears (for example, before or after corn plants come into ears/before and after the heading in rice). For the position of the plant, which is treated with the composition, the treatment may be performed on the flower cluster, or a part or whole of the plant. Further, the frequency of treating the plant with the composition may be one time or a plurality of times. When the frequency of treating the plant with the composition is a plurality of times, an additional treatment may be performed one to five times at an interval of 5 days to 15 days after the initial treatment. Specifically, it is preferred that an additional treatment is performed one time at an interval of 7 days.

The composition for increasing the yield of the plant according to the present invention may be used as, for example, a composition for increasing the yield of food and/or a composition for increasing the yield of a fodder crop, and the method for increasing the yield of the plant according to the present invention may be used as a method for increasing the yield of food and/or a method for increasing the yield of a fodder crop.

Hereinafter, the present invention will be specifically described through Examples, but the following Examples only illustrate one form of the present invention, and the scope of the present invention is not limited by the following Examples.

### Preparation Example 1

### 1. Preparation of Lysophosphatidylethanolamine

30 g of a purified egg lecithin DS-PL95E (Doosan Corp., 75% of phosphatidylcholine, 14% of phosphatidylethanolamine and 11% of balances) was dissolved in 60 mL of ethyl acetate. The phospholipase D 800 unit Sigma Company) originated from Streptomyces genus was mixed with 100 ml of sodium acetate (100 mM, pH 5.6) buffer solution containing 80 mM of CaCl₂ and 8 g of ethanolamine, and then, the resulting solution was mixed with the lecithin solution previously dissolved and was reacted at 35° C. for 13 hours while being stirred at 300 rpm. As a result of analyzing the reaction solution with HPLC, the content of phosphatidylethanolamine in the lecithin in the reaction solution was 79% and the content of phosphatidylcholine was 16%.

3 ml of Lecitase (10,000 IU/ml, Novo Nordisk Company) was added to the solution, and reacted at 35° C. for 6 hours while being vigorously stirred. 50 ml was extracted from the obtained reaction solution, put into a 250 ml round flask, concentrated under reduced pressure at 40° C. with a rotary vacuum evaporator to remove ethyl acetate, which was a solvent, treated with 100 ml of anhydrous ethanol, left to stand at −2° C. for one and a half hours, and then filtered. 8.7 g of the filtered material obtained was treated with 100 ml of a mixed solution of ethanol, ethyl acetate and water (=1:0.5:0.5, v/v/v), and heated for 30 minutes while being slowly stirred at 60° C. The heat-treated solution was filtered to remove impurities, and the filtrate was kept cold at −2° C. for 3 hours. Thereafter, the crystallized solution was filtered to obtain 4.8 g of the filtered material, and the filtered material obtained was treated with 80 ml of the mixed solution of ethanol, ethyl acetate and water (=1:0.5:0.5, v/v/v), heated for 30 minutes while being slowly stirred at 60° C., slowly cooled to −2° C., and then filtered. The filtered material was treated two times with the above mixed solution in the same manner, and then vacuum-dried at 30° C. As a result of analyzing the dried material with liquid chromatography, it could be seen that 1.6 g of lysophosphatidylethanolamine having a lecithin purity of 97% or more was obtained.

### 2. Preparation of Lysophosphatidylethanolamine Aqueous Solution

10% by weight of the lysophosphatidylethanolamine prepared above and 10% by weight of an ethanolamine salt of oleic acid having 18 carbon atoms and including one double bond were added to a mixed solvent consisting of 30% by weight of water, 14% by weight of isopropanol, 14% by weight of butanol, 14% by weight of hexanol and 8% by weight of oleyl alcohol, and stirred at 1,000 rpm, thereby preparing the composition.

### Experimental Example 1

### Effects on Corn (Variety: Mibaekchal)

The composition prepared as described above was diluted in water to obtain a diluted solution of the composition having a concentration of 10 ppm, and the corn variety Mibaekchal was treated with the diluted solution with the time period and frequency shown in the following Table 1.

For reference, the corn sowed on July 1 had 11 leaves on average as of August 9, which was the first treatment date (39th day after sowing), and the corn sowed on July 24 had 6 or 7 leaves on average as of August 9, which was the first treatment date (16th day after sowing).

TABLE 1

| | | | | | Period | |
|---|---|---|---|---|---|---|
| | | Treat- | Treat- | Treat- | until | |
| | Sowing | ment | ment | ment | primary | |
| | time | 1 | 2 | 3 | treatment | Total |
| | (Month, | (Month, | (Month, | (Month, | after | treatment |
| | Date) | Date) | Date) | Date) | sowing | frequency |
| Comparative | 7.1 | — | — | — | — | 0 |
| Example A | | | | | | |
| Example A1 | 7.1 | 8.9 | — | — | 39 | 1 |
| Example A2 | 7.1 | 8.9 | 8.16 | — | 39 | 2 |
| Example A3 | 7.1 | 8.9 | 8.16 | 8.23 | 39 | 3 |

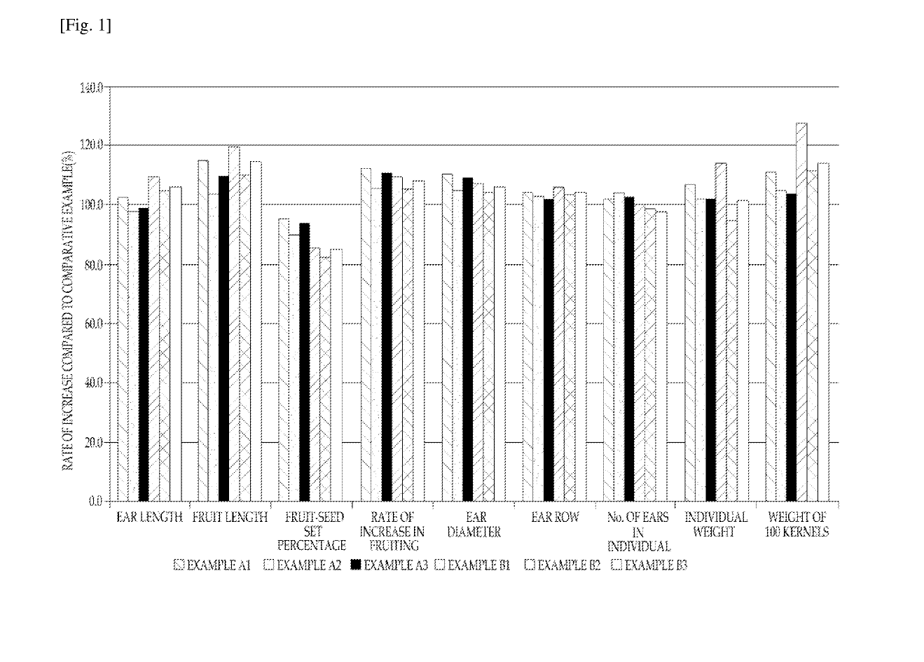

The treatment results of Examples A1 to A3 and Comparative Example A, in which the treatment was performed as described above are shown in the following Table 2 and FIG. 1.

TABLE 2

| | Comparative | | | |
|---|---|---|---|---|
| Treatment | Example A | Example A1 | Example A2 | Example A3 |
| Treatment | No treatment | One time | Two times | Three times |
| Kernel color | White | White | White | White |
| Ear length (cm) | 19.3 | 19.8 | 18.9 | 19.1 |
| Fruit length | 16.3 | 18.8 | 16.9 | 17.9 |
| (cm) | | | | |
| Length of non- | 3 | 1 | 2 | 1.2 |
| fruiting (cm) | | | | |
| Fruit-seed set | 84.5 | 94.9 | 89.4 | 93.7 |
| percentage (%) | | | | |
| Rate of | — | 10.4 | 4.9 | 9.2 |
| increase in | | | | |
| fruiting (%) | | | | |
| Ear diameter | 42.8 | 44.5 | 44.0 | 43.8 |
| (mm) | | | | |
| Ear row | 12.2 | 12.4 | 12.7 | 12.5 |
| No. of ears in | 436.9 | 467.1 | 446.3 | 445.7 |
| the individual | | | | |
| Individual | 179.6 | 199.4 | 188.3 | 186.6 |
| weight (g) | | | | |
| Weight of 100 | 31.3 | 32.4 | 31.9 | 33.9 |
| kernels (g) | | | | |
| Rate of | 100 | 111 | 104.8 | 103.9 |
| increase in | | | | |
| individual | | | | |
| weight (%) | | | | |

Referring to Table 2 and FIG. 1, it could be confirmed that the growth of the corn treated with the composition of the present invention was promoted, and accordingly, the size, number and maturity of corn kernels as well as the size and weight of ear corn were increased. It could be confirmed that Example A1 in which treatment with the composition was performed one time was the best among them.

### Experimental Example 2

### Effects on Corn (Variety: Miheugchal)

The composition prepared as described above was diluted in water to obtain a diluted solution of the composition having a concentration of 10 ppm, and the corn variety Miheugchal was treated with the diluted solution with the time period and frequency shown in the following Table 3. For reference, the corn variety Miheugchal sowed on July 12 had 10 leaves on average as of August 9, which was the first treatment date (28th day after sowing).

TABLE 3

| | | | | | Period | |
|---|---|---|---|---|---|---|
| | | Treat- | Treat- | Treat- | until | |
| | Sowing | ment | ment | ment | primary | |
| | time | 1 | 2 | 3 | treatment | Total |
| | (Month, | (Month, | (Month, | (Month, | after | treatment |
| | Date) | Date) | Date) | Date) | sowing | frequency |
| Comparative | 7.12 | — | — | — | — | 0 |
| Example B | | | | | | |
| Example B1 | 7.12 | 8.9 | — | — | 28 | 1 |
| Example B2 | 7.12 | 8.9 | 8.16 | — | 28 | 2 |
| Example B3 | 7.12 | 8.9 | 8.16 | 8.23 | 28 | 3 |

The treatment results of Examples B1 to B3 and Comparative Example B, which were treated as described above are shown in the following Table 4 and FIG. 1.

TABLE 4

| | Comparative | | | |
|---|---|---|---|---|
| Treatment | Example B | Example B1 | Example B2 | Example B3 |
| Treatment | No treatment | One time | Two times | Three times |
| Kernel color | Black | Black | Black | Black |
| Ear length (cm) | 18 | 19.65 | 18.8 | 19.1 |
| Fruit length | 14.1 | 16.85 | 15.5 | 16.2 |
| (cm) | | | | |
| Length of non- | 3.9 | 2.8 | 3.3 | 2.9 |
| fruiting (cm) | | | | |
| Fruit-seed set | 78.3 | 85.7 | 82.4 | 84.8 |
| percentage (%) | | | | |
| Rate of | — | 7.4 | 4.1 | 6.5 |
| increase in | | | | |
| fruiting (%) | | | | |
| Ear diameter | 43.2 | 45.7 | 44.9 | 45 |
| (mm) | | | | |
| Ear row | 14.1 | 14.1 | 13.9 | 13.8 |
| No. of ears in | 428.3 | 489.1 | 406 | 435 |
| the individual | | | | |
| Individual | 143.36 | 182.83 | 159.69 | 163.57 |
| weight (g) | | | | |
| Weight of 100 | 21.86 | 24.44 | 22.25 | 20.61 |
| kernels (g) | | | | |
| Rate of | 100 | 127.5 | 111.4 | 114.1 |
| increase in | | | | |
| individual | | | | |
| weight (%) | | | | |

Referring to Table 4 and FIG. 1, it could be confirmed that the growth of the corn treated with the composition of the present invention was promoted, and accordingly, the size, number and maturity of corn kernels as well as the size and weight of ear corn were increased. It could be confirmed that Example B1 in which treatment with the composition was performed one time was the best among them.

### Experimental Example 3

### Effects on Rice

The composition prepared as described above was diluted in water to obtain a diluted solution of the composition having a concentration of 10 ppm, and the rice was treated with the diluted solution with the time period and frequency shown in the following Table 5. In this case, the experiment was performed repeatedly three times.

TABLE 5

| | | | | | Period until | |
|---|---|---|---|---|---|---|
| | Transplanting | Treatment | Treatment | Treatment | primary | |
| | time | 1 | 2 | 3 | treatment | Total |
| | (Month, | (Month, | (Month, | (Month, | after | treatment |
| | Date) | Date) | Date) | Date) | transplanting | frequency |
| Comparative | 5.10 | — | — | — | — | 0 |
| Example C | | | | | | |
| Example C1 | 5.10 | 8.7 | — | — | 28 | 1 |
| Example C2 | 5.10 | 8.7 | 8.14 | — | 28 | 2 |
| Example C3 | 5.10 | 8.7 | 8.14 | 8.21 | 28 | 3 |

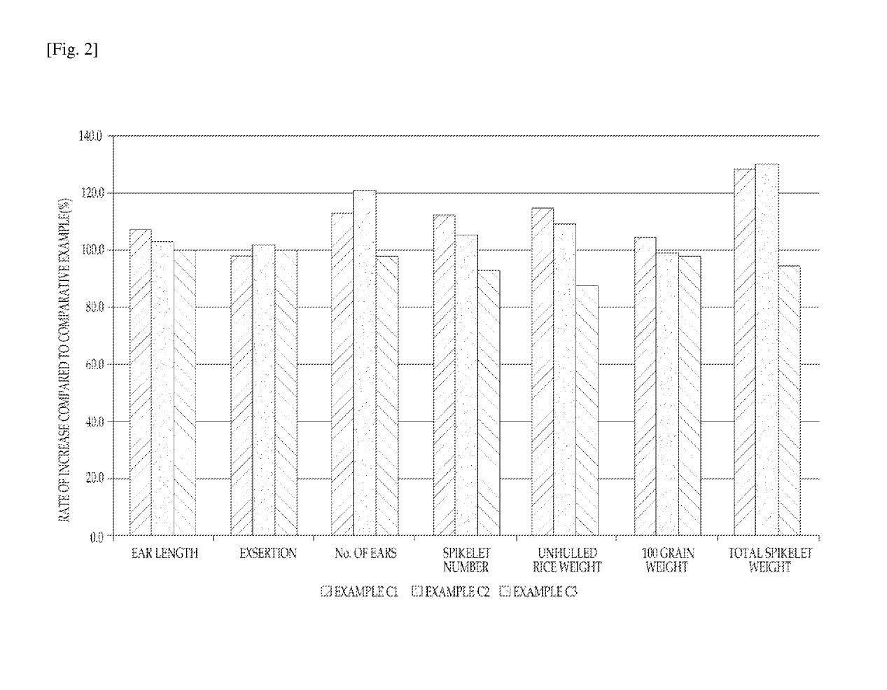

The treatment results of Examples C1 to C3 and Comparative Example C, in which the treatment was performed as described above are shown in the following Tables 6 and 7 (average value of experiments performed three times) and FIG. 2.

TABLE 6

| | | No. of | | | | | | |
|---|---|---|---|---|---|---|---|---|
| | | immature | | | | | | |
| | | grains | Ear | | No. of | | Unhulled | 100 |
| | | (Blue | length | Exsertion | ears | Spikelet | rice | grain |
| Repetition | Treatment | rice) | (cm) | (cm) | (ea) | number | weight | weight |
| Comparative | No | 148 | 17.9 | 5.3 | 29 | 71.8 | 1.92 | 2.44 |
| Example C1 | treatment | | | | | | | |
| Comparative | No | 68 | 18.1 | 5.3 | 28 | 76.4 | 1.98 | 2.32 |
| Example C2 | treatment | | | | | | | |
| Comparative | No | 63 | 18.5 | 5.2 | 23 | 72.2 | 1.93 | 2.72 |
| Example C3 | treatment | | | | | | | |
| Example C1-1 | One time | 21 | 20.3 | 4.6 | 24 | 91.3 | 2.55 | 2.6 |
| Example C1-2 | One time | 21 | 18.5 | 6 | 34 | 79.8 | 2.09 | 2.65 |
| Example C1-3 | One time | 26 | 19.6 | 5 | 33 | 76.4 | 2.02 | 2.53 |
| Example C2-1 | Two | 40 | 18.4 | 6.1 | 32 | 81.5 | 2.16 | 2.34 |
| | times | | | | | | | |
| Example C2-2 | Two | 46 | 19.4 | 5.2 | 30 | 81.5 | 2.37 | 2.52 |
| | times | | | | | | | |
| Example C2-3 | Two | 66 | 18.5 | 4.8 | 35 | 69.8 | 1.83 | 2.55 |
| | times | | | | | | | |
| Example C3-1 | Three | 32 | 18.9 | 6.3 | 24 | 77.3 | 1.82 | 2.41 |
| | times | | | | | | | |
| Example C3-2 | Three | 41 | 18 | 5 | 27 | 65.7 | 1.71 | 2.55 |
| | times | | | | | | | |
| Example C3-3 | Three | 32 | 17.6 | 4.6 | 28 | 62.5 | 1.57 | 2.38 |
| | times | | | | | | | |

TABLE 7

| | No. of | | | | | | | |
|---|---|---|---|---|---|---|---|---|
| | immature | | | | | | | Total |
| | grains | Ear | | No. of | | Unhulled | 100 | spikelet |
| | (Blue | length | Exsertion | ears | Spikelet | rice | grain | weight (10) |
| Repetition | rice) | (cm) | (cm) | (ea) | number | weight | weight | hills) |
| Comparative | 93 | 18.2 | 5.3 | 26.7 | 73.5 | 1.94 | 2.49 | 417.65 |
| Example C | | | | | | | | |
| Average | | | | | | | | |
| Example C1 | 22.7 | 19.5 | 5.2 | 30.3 | 82.5 | 2.22 | 2.59 | 537.14 |
| Average (% | (24.4) | (107.1) | (98.1) | (113.5) | (112.2) | (114.4) | (104.0) | (128.6) |
| compared to | | | | | | | | |
| Comparative | | | | | | | | |
| Example) | | | | | | | | |
| Example C2 | 50.7 | 18.8 | 5.4 | 32.3 | 77.6 | 2.12 | 2.47 | 543.33 |
| Average(% | (54.5) | (103.3) | (101.9) | (121.0) | (105.6) | (109.3) | (99.2) | (130.1) |
| compared to | | | | | | | | |
| Comparative | | | | | | | | |
| Example) | | | | | | | | |
| Example C3 | 35 | 18.2 | 5.3 | 26.3 | 68.5 | 1.7 | 2.45 | 395.33 |
| Average(% | (37.6) | (100.0) | (100.0) | (98.5) | (93.2) | (87.6) | (98.4) | (94.7) |
| compared to | | | | | | | | |
| Comparative | | | | | | | | |
| Example) | | | | | | | | |

Referring to Tables 6 and 7 and FIG. 2, it could be confirmed that the growth of rice treated with the composition of the present invention was promoted, and accordingly, the number of immature rice was decreased, and the ear length, the number of ears, the spikelet number, the unhulled rice weight, the 100 grain weight, the total spikelet weight and the maturity were all increased. It could be confirmed that Example C1 in which treatment with the composition was performed one time was the best among them.

### Preparation Example 2

1% by weight of the lysophosphatidylethanolamine prepared in Preparation Example 1, 7% by weight of an ethanolamine salt of oleic acid having 18 carbon atoms and including one double bond, 1.5% by weight of manganese and 0.5% by weight of molybdenum were added to a mixed solvent consisting of 70% by weight of water, 10% by weight of fermented alcohol and 10% by weight of glycerol, and stirred at 1,000 rpm, thereby preparing Composition D1.

### Preparation Example 3

1% by weight of the lysophosphatidylethanolamine prepared in Preparation Example 1 and 9% by weight of an ethanolamine salt of oleic acid having 18 carbon atoms and including one double bond were added to a mixed solvent consisting of 70% by weight of water, 10% by weight of hexanol and 10% by weight of glycerol, and stirred at 1,000 rpm, thereby preparing Composition D2.

### Preparation Example 4

1% by weight of the lysophosphatidylethanolamine prepared in Preparation Example 1 and 9% by weight of an ethanolamine salt of oleic acid having 18 carbon atoms and including one double bond were added to a mixed solvent consisting of 70% by weight of water, 10% by weight of fermented alcohol and 10% by weight of glycerol, and stirred at 1,000 rpm, thereby preparing Composition D3.

### Experimental Example 4

### Effects on Wheat (Variety: Keumkang)

Compositions D1 to D3 prepared above were diluted in water, and wheat was treated with a diluted solution of the composition having a concentration of 10 ppm with the time period and frequency shown in Table 8. In this case, the treatment was performed by spraying the diluted solution one time on May 6, which was immediately before the heading time.

TABLE 8

| | Treatment | Harvest | Total treatment |
|---|---|---|---|
| | (Month, Date) | (Month, Date) | frequency |
| Comparative | — | — | 0 |
| Example D | | | |
| Example D1 | 5.6 | 6.21 | 1 |
| Example D2 | 5.6 | 6.21 | 1 |
| Example D3 | 5.6 | 6.21 | 1 |

TABLE 9

| | Comparative | | | |
|---|---|---|---|---|
| Treatment | Example D | Example D1 | Example D2 | Example D3 |
| Ear length (cm) | 6.47 | 7.64 | 7.08 | 6.85 |
| Ear beard (cm) | 3.80 | 4.28 | 4.50 | 4.96 |
| Top beard | 10.27 | 11.92 | 11.58 | 11.80 |
| length (cm) | | | | |
| Spikelet | 26 | 35 | 30 | 31 |
| number (ea) | | | | |
| Weight (g) | 1.50 | 2.08 | 1.63 | 1.74 |
| Weight index | 100 | 139 | 109 | 116 |
| Defective | 17.00 | 3.51 | 4.71 | 9.87 |
| number/ | | | | |
| Spikelet | | | | |
| number (%) | | | | |
| Ear diameter | 8.15 | 10.16 | 8.65 | 9.07 |

Referring to Table 9, it could be confirmed that the growth of the wheat treated with the composition of the present invention was promoted, the defective rate of ears was decreased, and the size and weight of the wheat were increased. Further, when the composition of the present invention includes manganese and molybdenum, it could be confirmed that the growth of the wheat was further promoted.

### Experimental Example 5

### Effects on Wheat (Variety: Stephens)

Compositions D1 to D3 prepared above were diluted in water, and wheat was treated with a diluted solution of the composition having a concentration of 10 ppm with the time period and frequency shown in the following Table 10.

TABLE 10

| | Treatment | Harvest | Total treatment |
|---|---|---|---|
| | (Month, Date) | (Month, Date) | frequency |
| Comparative | — | — | 0 |
| Example D′ | | | |
| Example D1′ | 5.11 | 7.17 | 1 |
| Example D2′ | 5.11 | 7.17 | 1 |
| Example D3′ | 5.11 | 7.17 | 1 |

The treatment results of Examples D1′ to D3′ and Comparative Example D′ in which the treatment was performed as described above are shown in the following Table 11.

TABLE 11

| | Comparative | | | |
|---|---|---|---|---|
| Treatment | Example D′ | Example D1′ | Example D2′ | Example D3′ |
| Ear length (cm) | 6.23 | 8.26 | 8.36 | 7.32 |
| Ear beard (cm) | 5.33 | 5.12 | 4.61 | 5.27 |
| Top beard | 11.56 | 13.38 | 12.97 | 12.59 |
| length (cm) | | | | |
| Spikelet | 17 | 31 | 29 | 24 |
| number (ea) | | | | |
| Weight (g) | 1.18 | 2.87 | 2.79 | 2.00 |
| Weight index | 100 | 243 | 236 | 170 |
| Defective | 18.36 | 8.87 | 8.40 | 23.00 |
| number/ | | | | |
| Spikelet | | | | |
| number (%) | | | | |
| Ear diameter | 7.06 | 9.10 | 8.96 | 8.11 |

Referring to Table 11, it could be confirmed that the growth of the wheat treated with the composition of the present invention was promoted, the defective rate of ears was decreased, and the size and weight of wheat were increased. In addition, when the composition of the present invention includes manganese and molybdenum, it could be confirmed that the growth of the wheat was further promoted.

### INDUSTRIAL APPLICABILITY

When the present invention is used, there is no toxicity to the human body without causing side effects such as deformities and poor growth of a plant while the yield increase of the plant is effectively promoted, and the destruction of the environment may also be prevented. Furthermore, there is an effect that the economical efficiency may be enhanced because the yield increase may be achieved at a low cost.

1. A composition for increasing the yield of a plant, comprising:
at least one of lysophosphatidylethanolamine and lecithin.

2. The composition of claim 1, further comprising:
at least one of a fatty acid having 3 to 22 carbon atoms and salts thereof, and a mixed solvent of water and alcohol.

3. The composition of claim 1, further comprising:
at least one of iron, boron, copper, zinc, manganese and molybdenum.

4. The composition of claim 1, wherein at least one of lysophosphatidylethanolamine and lecithin is comprised in an amount of 1 to 50% by weight based on the total weight of the composition.

5. The composition of claim 2, wherein at least one of the fatty acid and salts thereof and the mixed solvent are comprised in an amount of 0.001 to 60% by weight and 10 to 99.9% by weight, respectively, based on the total weight of the composition.

6. The composition of claim 2, wherein the salt of the fatty acid is at least one selected from the group consisting of sodium salts, potassium salts, ammonium salts and ethanolamine salts.

7. The composition of claim 2, wherein the alcohol is at least one selected from the group consisting of ethanol, isopropanol, butanol, hexanol and oleyl alcohol.

8. The composition of claim 7, wherein the mixed solvent has a volume ratio of water:ethanol or isopropanol:butanol:hexanol:oleyl alcohol of 1:0.4 to 4.0 or 0.2 to 2.0:0.2 to 2.0:0.2 to 2.0:0.1 to 1.0.

9. A method for increasing the yield of the plant, comprising:
treating the plant with the composition for increasing the yield of the plant of claim 1 to promote the yield increase.

10. The method of claim 9, wherein the plant is at least one selected from the group consisting of corn, rice, barley, sorghum and wheat.

11. The method of claim 9, wherein a primary treatment is performed with the composition for increasing the yield of the plant before or after plants come into ears.
